(19) United States
(12) Patent Application Publication
(10) Pub. No.: US 2010/0181368 A1
(43) Pub. Date: Jul. 22, 2010

(54) GOLF CLUB ASSEMBLY USING ULTRASONIC WELDING

(75) Inventor: J. ANDREW GALLOWAY, ESCONDIDO, CA (US)

Correspondence Address: CALLAWAY GOLF C0MPANY, 2180 RUTHERFORD ROAD, CARLSBAD, CA, 92008-7328, US

(73) Assignee: CALLAWAY GOLF COMPANY, CARLSBAD, CA (US)

(21) Appl. No.: 12/632,467

(22) Filed: Dec. 7, 2009

Related U.S. Application Data
(60) Provisional application No. 61/140,763, filed on Dec. 24, 2008.

(51) Int. Cl. B23K 20/10

(52) U.S. Cl. 228/110.1

(57) ABSTRACT

A process for ultrasonic welding of a shaft to a golf club head is disclosed herein. The process involves positioning a tip end of a shaft within a bore of a hosel of the golf club head and imparting vibrational energy at least 20 kiloHertz to the interface to ultrasonically weld the shaft to the interior wall of the hosel. The diffusion of materials creates a strong attachment off the shaft to the golf club head.

### CROSS REFERENCES TO RELATED APPLICATIONS

The present application claims priority to U.S. Provisional Patent Application No. 61/140763, filed on Dec. 24, 2008.

### STATEMENT REGARDING FEDERALLY SPONSORED RESEARCH OR DEVELOPMENT

Not Applicable

### BACKGROUND OF THE INVENTION

1. Field of the Invention

The present invention relates to a golf club. More specifically, the present invention relates to a golf club assembly.

2. Description of the Related Art

The prior art discloses various methods to assembly golf clubs.

The joining of shafts to heads in golf club assembly typically utilizes adhesives and cure time. Press fits and crimping are sometimes used. Modern thin and strong materials used in steel shaft make deformation processes difficult. Carbon shafts are also adhesively bonded to shafts and cannot use crimping or press fits because the carbon configuration has relatively low shear and compression capabilities. A quick strong joining method is desired for rate assembly in golf club manufacture.

BRIEF SUMMARY OF THE INVENTION

The present invention overcomes these difficulties in steel shaft attachment and carbon shaft attachments.

The present invention enables quick, clean assembly of golf club shaft to golf club heads. This invention improves the joints contribution to the feel of the club when played in the game of golf.

One aspect of the present invention is a process for assembling a golf club. The process begins with placing a portion of a golf club head in an ultrasonic welding apparatus. The golf club head has a hosel. Next, a tip end of a shaft is positioned in the hosel. The shaft and the hosel are positioned within the ultrasonic welding apparatus. Next, the hosel and shaft are ultrasonically welded to assemble the golf club.

Having briefly described the present invention, the above and further objects, features and advantages thereof will be recognized by those skilled in the pertinent art from the following detailed description of the invention when taken in conjunction with the accompanying drawings.

BRIEF DESCRIPTION OF THE SEVERAL VIEWS OF THE DRAWINGS

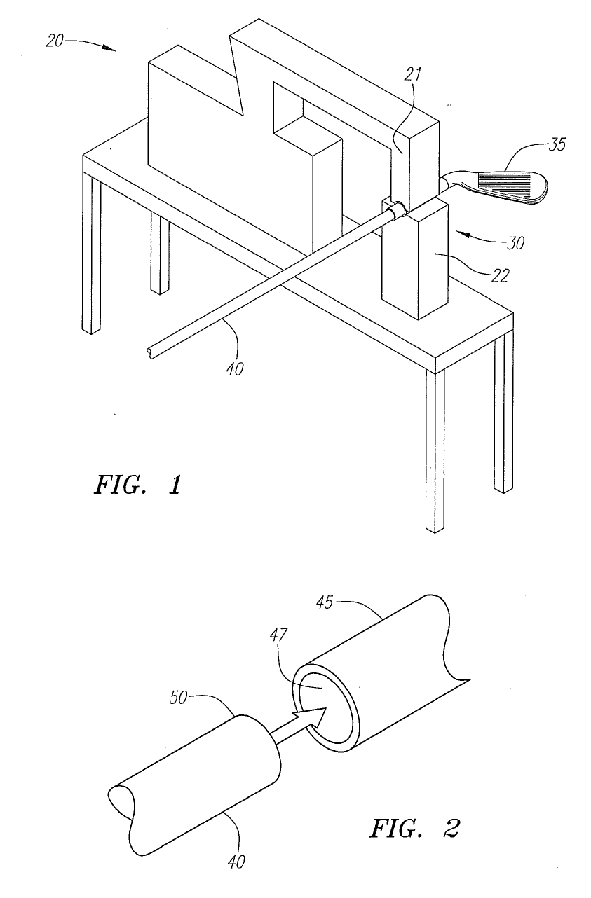

FIG. 1 is a perspective view of an ultrasonic machine with a golf club.

FIG. 2 is an isolated view of a shaft and golf club head joining area.

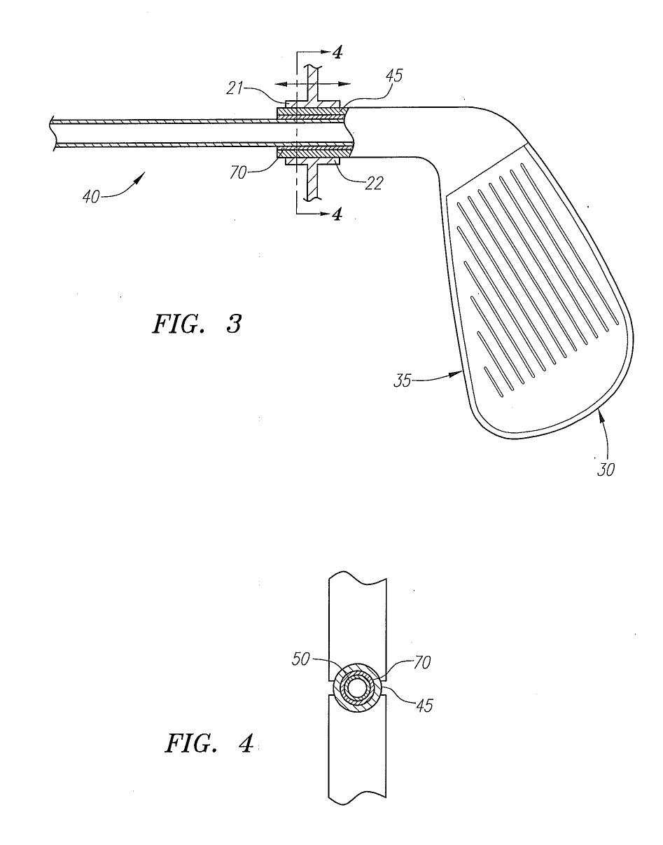

FIG. 3 is an enlarged view of an ultrasonic machine with a golf club.

FIG. 4 is a cross-sectional view along line A-A of FIG. 3.

### DETAILED DESCRIPTION OF THE INVENTION

The present invention consists of an ultrasonic welding machine, modified to fit the golf club joining area. The machine vibrates the joint area and causes the faying metal surfaces to diffuse slightly into the co-joined opposing metal. The process is applicable for carbon to metal heads through the selection of the metal for application of the ultrasonic vibration motion, thus diffusing the metal into the carbon composite.

The golf club head is preferably an iron-type golf club head. Alternatively, the golf club head is a wood type golf club head or a putter-type golf club head. The golf club head is preferably composed of a stainless steel material. Alternatively, the golf club head is composed of a titanium alloy material, another iron-alloy material, or a multiple material composition.

The shaft is preferably composed of a graphite material. Alternatively, the shaft is composed of a stainless steel material, an aluminum alloy material, a titanium alloy material, or a multiple material composition.

Ultrasonic welding of metal and plastic materials involves transforming electrical signals into mechanical vibrations and vibrating adjacent pieces between a sonotrode and an anvil. The vibrating frictional forces between the pieces weld the adjacent pieces together. A sonotrode and anvil are used to transfer energy from the sonotrode to the interface of the adjacent pieces. Typical frequencies are 20, 30 and 40 kiloHertz. A typical ultrasonic welding device is disclosed in Patrikios et al., U.S. Pat. No. 6,070,777 for an Automated Energy Efficient Ultrasonic Welder, which is hereby incorporated by reference in its entirety.

The present invention is a new process for assembly of the golf club shafts to the golf club head. The invention decreases the time and facility overhead for production of assembled golf clubs. The invention improves the feel of the joint by removing the epoxy adhesive, which can act to dampen the vibrations that travel from the golf club head to the shaft during impact with a golf ball.

As shown in FIGS. 1-2, an ultrasonic apparatus 20 comprises a sonotrode 21 and an anvil 22. A golf club 30 is placed within the ultrasonic apparatus 20 for assembly. As discussed above, the golf club 30 has a golf club head 35 with a hosel 45 having a bore 47. The golf club 30 also has a shaft 40 with a tip end 50. The tip end 50 of the shaft 40 is placed within the bore 47 of the hosel 45, and then positioned in the ultrasonic apparatus 20 in relation to the sonotrode 21 and the anvil 22. The sonotrode imparts vibrational energy preferably at at least 20 kiloHertz to an interface of the tip end 50 of the shaft 40 and the hosel 45 to ultrasonically weld the pieces together by diffusing the materials into each other.

FIGS. 3 and 4 illustrate a slightly different embodiment wherein a separate material 70 is positioned between the interior wall of the hosel 45 and the tip end 50 of the shaft 40 to further enhance the ultrasonic weld. The separate material 70 is preferably a metal, but alternatively is a composite or plastic material.

Various golf club heads are used with the present invention, and several are disclosed below.

Gibbs, et al., U.S. Pat. No. 7,163,468 is hereby incorporated by reference in its entirety.

Galloway, et al., U.S. Pat. No. 7,163,470 is hereby incorporated by reference in its entirety.

Williams, et al., U.S. Pat. No. 7,166,038 is hereby incorporated by reference in its entirety.

Desmukh U.S. Pat. No. 7,214,143 is hereby incorporated by reference in its entirety.

Murphy, et al., U.S. Pat. No. 7,252,600 is hereby incorporated by reference in its entirety.

Gibbs, et al., U.S. Pat. No. 7,258,626 is hereby incorporated by reference in its entirety.

Galloway, et al., U.S. Pat. No. 7,258,631 is hereby incorporated by reference in its entirety.

Evans, et al., U.S. Pat. No. 7,273,419 is hereby incorporated by reference in its entirety.

Hocknell, et al., U.S. Pat. No. 7,413,250 is hereby incorporated by reference in its entirety.

From the foregoing it is believed that those skilled in the pertinent art will recognize the meritorious advancement of this invention and will readily understand that while the present invention has been described in association with a preferred embodiment thereof, and other embodiments illustrated in the accompanying drawings, numerous changes, modifications and substitutions of equivalents may be made therein without departing from the spirit and scope of this invention which is intended to be unlimited by the foregoing except as may appear in the following appended claims. Therefore, the embodiments of the invention in which an exclusive property or privilege is claimed are defined in the following appended claims.

I claim as my invention the following

1. A process for assembling a golf club, the process comprising:
placing a portion of a golf club head in an ultrasonic welding apparatus, the golf club head having a hosel;
positioning a tip end of a shaft in the hosel, the shaft and the hosel positioned within the ultrasonic welding apparatus; and
ultrasonically welding the hosel to shaft to assemble the golf club.

2. The process according to claim 1 wherein ultrasonically welding the hosel to shaft comprises imparting mechanical vibrations through a sonotrode of the ultrasonic welding apparatus at a frequency of at least 20 kiloHertz.

3. The process according to claim wherein the golf club head is composed of a titanium alloy material.

4. The process according to claim wherein the golf club head is composed of a stainless steel material.

5. The process according to claim wherein at least of portion of the golf club head is composed of a titanium alloy material.

6. The process according to claim wherein at least of portion of the golf club head is composed of an iron-alloy material.

7. The process according to claim wherein the golf club head is an iron-type golf club head.

8. The process according to claim wherein at least of portion of the shaft is composed of a stainless steel material.

9. The process according to claim wherein at least of portion of the shaft is composed of a graphite material.

10. The process according to claim wherein at least of portion of the shaft is composed of an aluminum alloy material.

11. A process for assembling a golf club, the process comprising:
placing a portion of a golf club head in an ultrasonic welding apparatus, the golf club head having a hosel, the golf club head composed of a stainless steel material;
positioning a tip end of a shaft in the hosel, the shaft composed of graphite material, the shaft and the hosel positioned within the ultrasonic welding apparatus; and
ultrasonically welding the hosel to shaft to assemble the golf club.

12. A process for assembling a golf club, the process comprising:
placing a portion of a golf club head in an ultrasonic welding apparatus, the golf club head having a hosel, the golf club head composed of a metal material;
positioning a tip end of a shaft in the hosel, the shaft composed of graphite material, the shaft and the hosel positioned within the ultrasonic welding apparatus; and
ultrasonically welding the hosel to shaft to assemble the golf club.

13. The process according to claim 12 further comprising placing a separate material between the shaft and the hosel.
